(19) United States
(12) Patent Application Publication
(10) Pub. No.: US 2009/0224028 A1
(43) Pub. Date: Sep. 10, 2009

(54) SELECTIVE SOLDERING APPARATUS WITH JET WAVE SOLDER JET AND NITROGEN PREHEAT

(75) Inventors: Alexander J. Ciniglio, Essex (GB); Charles Kent, Essex (GB); Darren Harvey, Essex (GB); Colin Drain, Essex (GB)

Correspondence Address: DICKSTEIN SHAPIRO LLP, 1825 EYE STREET NW, Washington, DC, 20006-5403, US

(73) Assignee: PILLARHOUSE LIMITED, Widford, Chelmsford, Essex (GB)

(21) Appl. No.: 11/569,589

(22) PCT Filed: May 24, 2005
(86) PCT No.: PCT/GB2005/002032

§ 371 Date: Aug. 27, 2007

(30) Foreign Application Priority Data
May 24, 2004 (GB) 0411573.9

(51) Int. Cl. B23K 31/02; B23K 3/06

(52) U.S. Cl. 228/219; 228/33

(57) ABSTRACT

Solder is pumped through a nozzle to produce a jet of solder and leads on a printed circuit board are passed through the jet to solder them to the board tracks. The nozzle is mounted on a flange held between slip rings so that the nozzle can be rotated to change the direction of the jet. A nitrogen conduit may be provided in-line with the jet to provide a nitrogen atmosphere. A thin plate downstream of the nozzle outlet to contact the jet and inhibit sideways fluctuations when leads are passed sideways through the jet. The apparatus may also include a tube for delivering heated nitrogen gas to pre-heat a region to be soldered.

The present invention relates to a selective soldering apparatus. In particular the invention relates to a selective soldering apparatus which uses an arcuate jet of solder.

Components to be soldered, particularly leads projecting through the underside of a circuit board, are passed through the upper surface of an arc formed by the jet of solder. This JetWave (trade mark) system is effective at soldering closely spaced leads without solder bridging. However, although the jet is narrow in its lateral dimension it is relatively long in its axial direction, the direction of the jet. It is possible to solder leads by passing them widthways across the jet as well as along the length of the jet. However, where a row of leads lays between two components on the underside of the board there may not be room for the jet to fit sideways between the components. Thus, we have previously used an X-Y-Z mechanism for handling the board, which allows the board to be rotated in the plane of the board before being translated to run a row of leads through the solder jet. The board itself may be passed in a horizontal plane across the solder jet, or it may be passed at an angle to the horizontal.

The provision of an X-Y-Z handling mechanism for the board is bulky and expensive. There is a need for a compact, low cost soldering apparatus which nevertheless allows use of the jet wave soldering principle on all types of board, including those with components mounted on the underside.

Thus, in accordance with one aspect of the invention, we provide a soldering apparatus having a solder bath, a nozzle assembly having a nozzle, and a pump for pumping solder to the nozzle, wherein the nozzle assembly is rotatable in the horizontal plane to change the orientation of the nozzle.

By changing the direction of the nozzle, it is not necessary to rotate the board in order to align component leads with the nozzle, instead the nozzle can be rotated.

The invention is particularly suitable for use with a nozzle of the jet wave type, in which an arcuate jet of solder is pumped from the nozzle. Preferably the nozzle is mounted on a solder bath which is movable in the horizontal plane, the X-Y direction.

Thus, the board may be held stationary in the horizontal plane and the bath and nozzle moved to solder different portions of the board. To move the nozzle beneath the board without contacting components which are not to be soldered to the board, the height of the solder may be reduced, for example by reducing the flow rate of solder through the solder jet, or the nozzle lowered relative to the underside of the board.

Once the nozzle is at the required position, the flow of solder is increased, or the nozzle raised relative to the board, to dip the leads to be soldered into the solder surface.

Preferably the bath is also movable vertically, in the Z direction, to bring the solder into contact with the leads on the underside of the board. In the alternative, or additionally, the board may be raised and lowered to bring the leads to the level of the solder surface.

With the jet wave system, the jet nozzle is translated along a line of leads to be soldered. As mentioned above, the jet may be directed along the line of leads or transverse to the line of leads, depending on the space available.

To rotate the nozzle, we prefer to provide an apparatus which is separate to the nozzle assembly. Thus, we provide a nozzle which is mounted on a rotary bearing to allow the nozzle to be rotated in a horizontal plane. An apparatus for rotating the nozzle comprises a mechanical assembly which contacts the nozzle to rotate it. A pair of fingers may be provided, which sit either side of the nozzle and the fingers moved in a circle to twist the nozzle.

Preferably the apparatus for rotating the nozzle is in a fixed position. The nozzle and solder bath are moved to the position of the rotary mechanism which then engages the nozzle to rotate it.

The fingers are rotated by a stepper motor to control the rotation of the fingers, and to position the nozzle in any desired orientation. For most applications, it is sufficient to orient the nozzle in the X or Y direction, i.e. rotate the nozzle through steps of 90 degrees, but other angular orientations are, of course, possible.

When a line of leads is moved across the axis of the jet wave, there is a tendency for the solder jet to oscillate sideways, destabilising the jet. To ensure reproducible soldering performance a stable jet is desirable.

According to another aspect of the invention we provide a solder nozzle comprising an outlet through which a jet of solder is pumped in a plane, and a plate of material extending in the plane, the jet of solder contacting the plate. The solder path between the nozzle outlet and the plate is thus stabilised and the jet is resistant to being drawn sideways by the leads passing through the solder jet.

Many customers specify that soldering must be done in a nitrogen atmosphere, that is, its oxygen content must be below a set level, in order to ensure the quality of the solder joint.

The complete soldering apparatus may be held in a nitrogen purged housing, but it is difficult to maintain the required low level of oxygen. Thus, we provide a nitrogen jacket around the soldering nozzle itself. In particular, we provide a nitrogen conduit in the axial plane of the solder jet, the nitrogen flowing through the conduit to exit near the jet.

In a soldering operation, the joints to be soldered are fluxed before soldering and the board is then heated to activate the flux. This will also reduce the thermal shock caused when the hot solder contacts the board, and help to pull solder through the board when soldering throughways in the board. However, the rate of heating of the board must be controlled as many components cannot tolerate rapid heating, typically no more than 2.5° C. per second.

Once the board is heated to activate the flux, it is then necessary to solder all the components within a short period of time, typically less than one minute.

Nevertheless some components can be heated at a faster rate. Thus, another aspect of the invention provides a method and apparatus for heating a region of a circuit board prior to soldering, in which heated nitrogen gas is flowed to the region to be soldered. The nitrogen may be heated to 250° C. to 300° C. The heated nitrogen flow may be part of the flow through the solder jet.

The invention will be further described by way of example with reference to the accompanying drawings, in which:

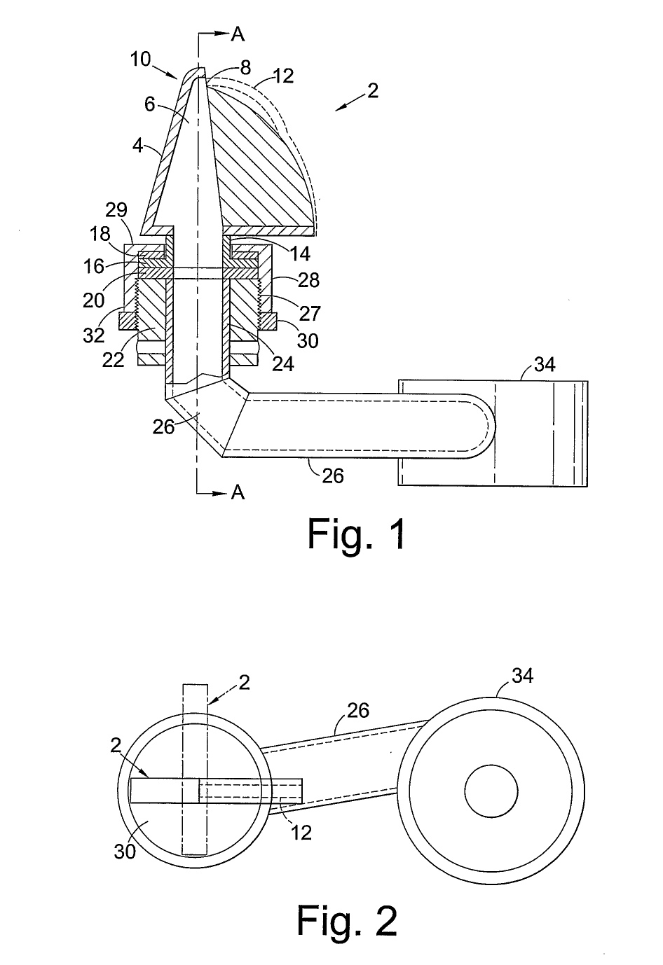

FIG. 1 is a cross-section through a jet-wave type soldering nozzle and pump assembly forming an embodiment of the invention;

FIG. 2 is a schematic plan view of the nozzle assembly of FIG. 1;

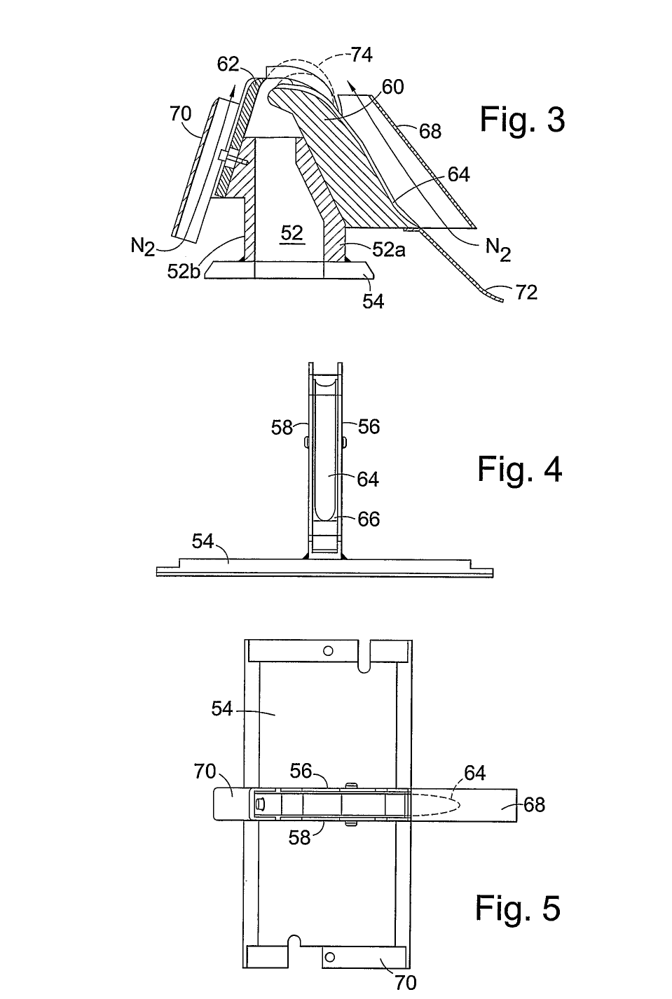

FIG. 3 is a cross-section through a jet-wave type soldering nozzle forming a second embodiment of the invention;

FIG. 4 is an end view of the nozzle of FIG. 3 with a nitrogen conduit cover removed;

FIG. 5 is a plan view of the nozzle of FIG. 3;

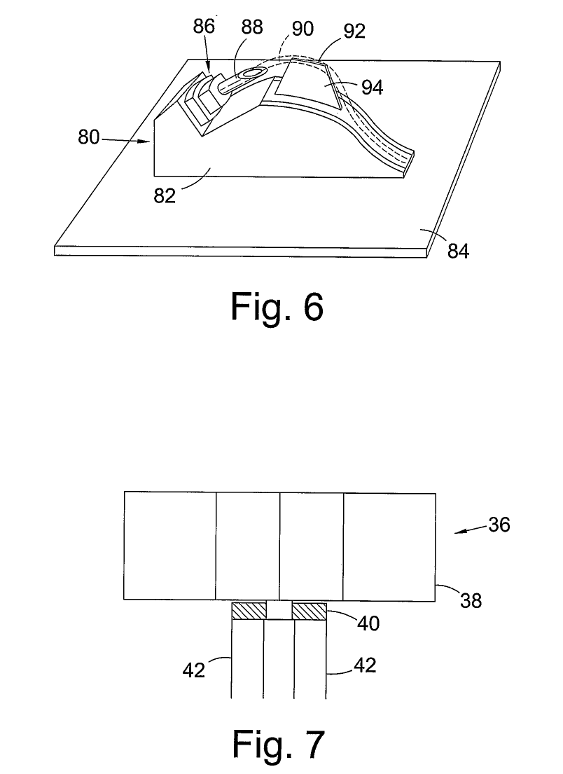

FIG. 6 is a perspective view of the third embodiment;

FIG. 7 is a side view of an apparatus for rotating the nozzle of FIGS. 1 to 6;

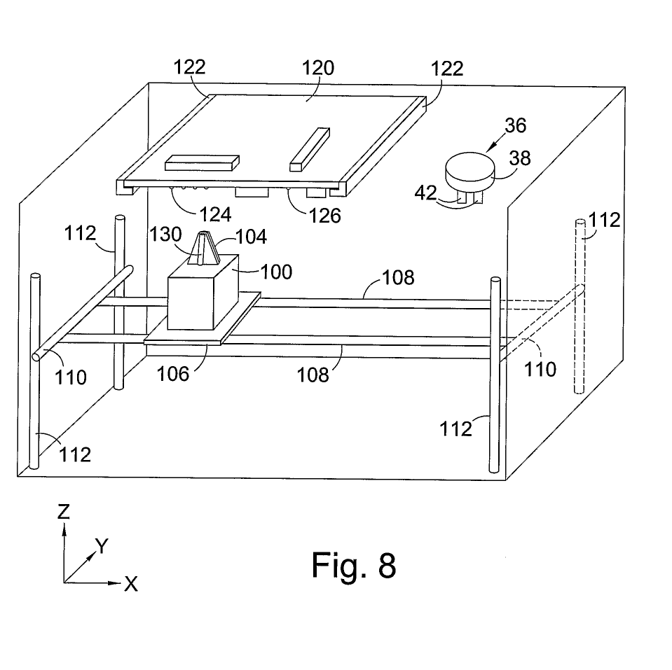

FIG. 8 is a schematic illustration of a soldering apparatus embodying a nozzle of the invention;

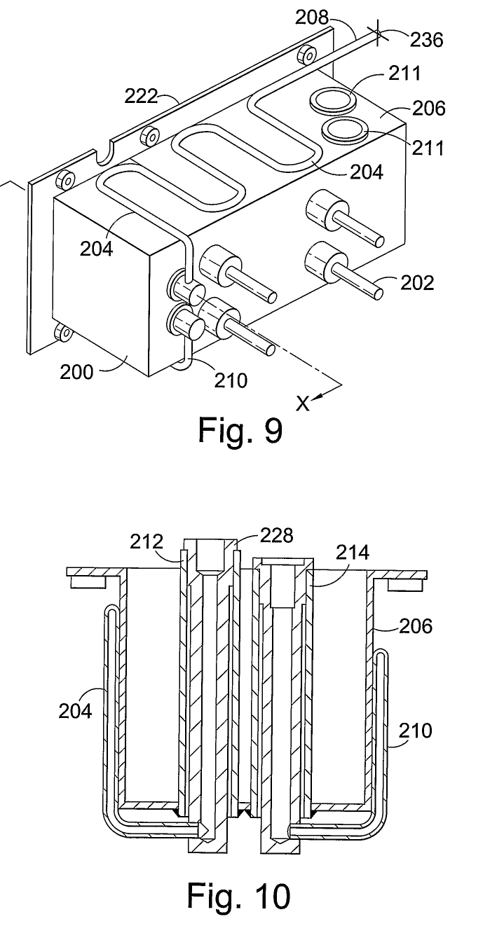

FIG. 9 is an underneath perspective view of a solder bath of another embodiment of the invention, having a nitrogen gas pre-heat facility for heating a lead or joint prior to soldering;

FIG. 10 is a cross-section along the line X-X of FIG. 9, and

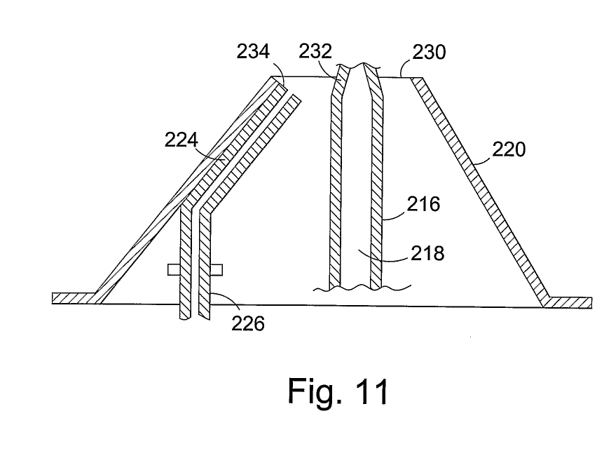

FIG. 11 is a cross-section through a cover for the bath of FIGS. 9 and 10.

FIG. 1 shows in cross-section a first embodiment of a rotatable solder nozzle 2 of the invention. The nozzle 2 has an upper body 4 defining a chamber 6 having an outlet 8 at an upper end 10. In use, molten solder is pumped through chamber 6 to exit outlet 8 in the manner of a stream or jet 12, illustrated in dotted outline in FIG. 1. Leads or other component parts to be soldered are passed through the solder jet. This may be achieved by moving the leads through the solder jet with the nozzle stationary, or, as in our preferred embodiment, by moving the jet, across the leads by moving the nozzle underneath a stationary board.

As seen from FIG. 2, the body 4 is generally elongate in one direction. Body 4 is mounted to be rotatable about an axis A-A. Body 4 has a cylindrical portion 14 centred on axis A-A and ending in a laterally extending circular flange 16. Flange 16 is mounted between two slip washers 18, 20. Washer 18, 20 may be formed from a suitable bearing material. The bearing material described in EP-A-558439 may be suitable. Washer 20 is supported on a mounting collar 22 which is attached to the end 24 of a conduit 26 by a grub screw, for example, and has a threaded outer surface 27. A compression nut 28 has an end collar 29 which bears on upper slip washer 20 and is screwed onto the threaded collar 22 to compress the flange 16 between the slip washer 18, 20 and end 24 of the solder conduit 26.

The compression nut 28 is fixed in place by a lock nut 30, screwed up against the lower edge 32 of the nut 28.

Thus, the nozzle 2 is held between the slip washers 18, 20 and sufficiently free to be rotated between the slip washers 18, 20.

It will be appreciated that flange 16 should be gripped lightly enough to allow forced rotation of the nozzle but to prevent any inadvertent rotational movement.

Nozzle chamber 6 is fed with molten solder through conduit 26 from a pump 34 which is immersed in a bath of molten solder, as typically used in the art.

The shape of the solder jet 12 will depend on the shape of the outlet 8 and the flow rate of pump 34. The pump 34 is controlled to maintain a relatively constant shape for the jet 12 so that leads can be passed through the jet.

The leads or other components may be passed laterally of the jet (into or out of the paper in FIG. 1) or along the length of the jet. With the arrangement in FIG. 1, a board may be passed at an angle to the horizontal along the length of the jet, to clear the upper end 10 of the nozzle 2. The height or direction of the jet may be varied by changing the pump speed.

The presence of components on the underside of a printed circuit board will often restrict access to leads which are to be soldered. To overcome this, the board may be rotated. However, we prefer an arrangement in which the nozzle 2 is rotated.

FIG. 7 shows one device 36 for rotating the nozzle 2. Rotation device 36 comprises a stepper motor 38 supporting a plate 40 having two downwardly extending fingers 42. To rotate the nozzle 2, the nozzle is moved clear of any PCB which is being soldered and raised between the finger 42, which straddle the nozzle body 2 about the axis A-A, as illustrated in dotted outline in FIG. 2. Motor 38 is then actuate to rotate plate 40 and fingers 42 in turn rotate the nozzle 2 to a decided orientation.

FIGS. 3 to 5 illustrate a second embodiment of a solder nozzle according to the invention. The nozzle 50 has a lower chamber 52 with a plate 54 at its lower end. Plate 54 is fixed direct to a solder conduit or cover of a solder bath as known in the art for solder nozzles, to pump solder through the nozzle. In place of plate 54, a circular flange as for flange 20 of the FIG. 1 embodiment may be provided, for rotatably mounting the nozzle in a structure as shown in FIG. 1. Chamber 52 is formed by two axial end walls 52a, 52b, and a pair of thin side walls 56, 58 mounted on the end walls 52a, 52b. The upper region of chamber 52 is defined between the side walls 56, 58 by a nose 60 and a lip 62 mounted on the respective axial end walls 52a, 52b. Nose 60 has a channel 64 formed in its outer surface 66. Mounted on the nose 60 and lip 62 are conduits 68, 70 for nitrogen gas. The conduits 68, 70 are of the same width as the nose 60 and lip 62 and end walls 52a, 52b, they do not extend widthways of the nozzle chamber. In use, solder is pumped through chamber 52 to form a jet 74, shown in dotted outline in FIG. 3, the solder flowing back to the solder bath via channel 64 and a run-off lip 72. The solder thus flows through nitrogen conduit 68. Nitrogen gas is fed into the lower end of the conduits 68, 70, to exit near the solder jet 74. It has been found that this provides a sufficient nitrogen atmosphere around the jet 74. Similar nitrogen conduits may be provided on the embodiment of FIGS. 1 and 2.

FIG. 6 illustrates a third embodiment of the invention. In this embodiment, sidewalls or a cover providing a conduit for nitrogen gas have been omitted for clarity. Illustrated in FIG. 6 is a nozzle 80 having a body 82 which is mounted on a plate 84 forming a cover for a solder bath. Solder is pumped into the body 82 which is mounted on a plate 84 forming a cover for a solder bath. Solder is pumped into the body 82 from beneath the plate, as known in the art. Body 82 has an outlet 86 in the form of a cylindrical cross-section spout 88. A jet 90 of solder is pumped from spout 88 and hits an upper edge 92 of a plate 94. The plate 94 serves to stabilise the free end of the solder jet 90.

If leads to be soldered are passed sideways through the jet 90, in the direction of arrow B-B, there is a tendency for the jet to oscillate sideways and the height of the jet may fluctuate, which may result in a variable quality solder joint.

Provision of the fin-like plate 92 stabilises the jet against the sideways movement.

The plate 92 may be incorporated in the embodiment of FIGS. 1 and 2 and FIGS. 3 to 5.

The solder nozzle of this invention preferably has a jet outlet of less than 40 mm wide in the horizontal plane, and preferably less than 12 mm, more preferably less than 6 mm thick. A generally cylindrical jet formed from an opening having maximum diameter of about 12 mm is preferred. An opening with a diameter of 6 to 12 mm is preferred. A diameter as small as about 2.5 mm may also be useful.

The material from which the solder jets are fabricated include cast iron and titanium.

In one preferred embodiment the fin-like plate is wetted by the solder.

FIG. 8 shows schematically a solder bath 100 with a pump and solder nozzle 104. Nozzle 104 is of the type described in FIGS. 1 and 2, optionally as modified by FIGS. 3 to 5 or FIG. 6. Bath 100 is mounted on a platform 106 carried by an X,Y,Z mechanism. Such an arrangement is well known in the art and is illustrated schematically here by lead screws 108, 110, 112 which are driven by electric motors (not shown) to raise and lower the bath, the Z direction, and move the bath in the horizontal plane, typically in the X or Y direction, but a combined XY movement is possible.

A printed circuit board 120 is held on rails 122. A mechanical fiducial system may be provide to ensure that board 120 is correctly positioned, or a optical sensor on platform 106 may determine the location of the board relative to the solder nozzle.

To one side of the rails 122, a nozzle rotating apparatus 36 is mounted.

It can be seen that board 120 has a first row of leads 124 extending in the X direction and a second row 126 extending in the Y direction.

The soldering apparatus is computer controlled. Prior to a soldering operation on a series of identical boards, an operator programs the apparatus to input the start and finish points of the rows of leads and the required nozzle orientation. For example, some rows may require that the nozzle be oriented with the solder jet directed along the line of the leads, for others the jet maybe transverse to the row.

In this particular example, the nozzle 104 is aligned with the solder jet flowing in the X direction, and leads 124 are soldered by passing the nozzle in the X direction lengthways of the row 124. The height of the platform 106 is determined by an optical sensor which detects the height of the solder jet. Typically the solder jet is positioned so that the leads to be soldered dip into the jet by about 1.5 mm. After leads 124 have been soldered the platform 106 is lowered and moved to position the nozzle 102 beneath the fingers 42 of the rotating apparatus 36. The nozzle 102 is then raised to position it between the fingers 42 and stepper motor 38 actuated to rotate the fingers and rotate the nozzle through 90 degrees. The platform 104 is then lowered and moved to position the nozzle under leads 126. The platform is then raised and moved in the Y direction to pass the solder jet over the leads 126.

It will be appreciated that nozzle 2 need only be returned to the rotating apparatus 36 when the direction of alignment of the nozzle 102 is to be changed.

In a preferred form of the apparatus we also provide a nitrogen pre-heater for heating selected parts of the board prior to soldering. The nitrogen pre-heater may be mounted on platform 106. Heated nitrogen gas, typically heated to 250° C. or greater with a volume flow rate of about 4 litres per minute is directed through a tube 130 onto selected parts of the board prior to the soldering operation to pre-heat the board and activate or dry the flux.

FIG. 9 is a perspective, underneath view of an embodiment of a solder bath 200 for delivering heated nitrogen gas to a selected board part prior to soldering. Solder bath 200 has four pins 202 for securing the bath to a carriage such as carriage 106 in FIG. 8. Referring to FIGS. 9 and 10, a thermally conductive metal tube or conduit 204 is mounted flush against a sidewall 206 of the metal bath 200 to be in thermal contact with the bath. Tube 204 follows a sinuous path to increase the length of tube in thermal contact with the bath wall 206. Tube 204 is fed with nitrogen gas through an end 208. Also shown is a second tube 210 which follows a shorter path in contact with the bath walls.

It will be appreciated that in use the bath 206 and tubes 204, 210 are encased in insulation and solder in the bath is heated by electrical heaters housed in tubes 211.

Referring to FIG. 9, tube 204 feeds into a vertical feed pipe 212 which passes inside the bath 207, extending up through molten solder (not shown) in the bath.

The second tube 210 also feeds nitrogen into a second vertical feed pipe 214.

Referring to FIG. 11, this shows schematically a nozzle 216 into which is pumped molten solder 218 from the bath 200 by a pump, not shown. Such apparatus is well known in the art. Around the nozzle is a cover or shroud 220. Cover 220 extends across the upper surface of the solder bath 200 and is sealed to the bath upper rim 222. The space between the solder 218 in the bath 200 and cover 220 is filled with nitrogen gas from feed pipe 214.

Attached to cover 220 is a nitrogen delivery tube 224. The lower end 226 of tube 224 is positioned to be received in the open upper end 228 of feed pipe 212 when cover 220 is mounted on the bath rim 222.

In use, nitrogen gas is fed into the bath 200 through tube 210 and feed pipe 214 to provide a nitrogen atmosphere above the solder and exits via the aperture 230 of cover 220, to provide a nitrogen atmosphere around the outlet 232 of nozzle 216.

For selective pre-heating of a joint or lead before it is soldered, nitrogen is fed through tube 204, and feed pipe 212 to tube 224 where it exits the open end 234 of tube 224. The bath is positioned to direct the flow of gas from tube 224 on to the joint or lead to be heated. The heated nitrogen gas is directed onto the joint for a predetermined length of time, as noted above. The nitrogen gas may be heated sufficiently by flow through tube 204 which is in thermal contact with the bath wall 206, which will be at the temperature of the molten solder in the bath. The nitrogen may also be pre-heated before being fed into tube 204, if desired or necessary. The nitrogen flow to tube 204 is reduced or shut off as necessary during the soldering operation by an electrically controlled valve 236.

1. A selective soldering apparatus having a solder bath, a nozzle assembly having a nozzle, and a pump for pumping solder to the nozzle, wherein the nozzle assembly is rotatable in the horizontal plane to change the orientation of the nozzle.

2. A soldering apparatus as claimed in claim 1, wherein a jet of solder is pumped from the nozzle.

3. A soldering apparatus as claimed in claim 1, wherein means is provided to move the solder bath in the horizontal plane.

4. A soldering apparatus as claimed in claim 3, wherein means is provided to move the solder bath in the vertical plane.

5. A soldering apparatus as claimed in claim 1, wherein means is provide to rotate the nozzle.

6. In combination, a solder nozzle mounted on a rotary bearing to allow the nozzle to be rotated in a horizontal plane and an apparatus for rotating the nozzle, the apparatus contacting the nozzle to rotate it.

7. The combination of claim 6, wherein the apparatus for rotating the nozzle comprises fingers which straddle the nozzle, the fingers being moved in a circle to twist the nozzle.

8. A soldering apparatus as claimed in claim 5, wherein the means for rotating the nozzle is in a fixed position and the nozzle and solder bath are movable to engage the nozzle with the means to rotate the nozzle.

9. A solder nozzle comprising an outlet through which, in use, a jet of solder is pumped in a plane, and a plate of material extending in the plane downstream of the outlet and positioned so that, in use, the jet of solder contacts the plate.

10. A solder nozzle comprising an outlet through which, in use, a j et of solder is pumped in a plane, wherein a conduit for nitrogen gas is provided in the axial plane only of the solder jet, the nitrogen flowing through the conduit to exit near the jet.

11. A method of selectively heating a region of a circuit board prior to soldering, in which heated nitrogen gas is flowed to the region to be soldered.

12. Selective soldering apparatus comprising a solder bath for holding molten solder and a nozzle fed with solder from the bath by a pump, the nozzle having an outlet end for delivering solder to a joint to be soldered, wherein by a conduit for nitrogen gas, the conduit having an outlet end proximal of the nozzle.

13. Apparatus as claimed in claim 12, wherein the conduit is in thermal contact with solder in the bath to heat nitrogen gas flowing through the conduit.

14. Apparatus as claimed in claim 13, wherein the conduit is mounted on a wall of the bath.

15. Apparatus as claimed in claim 14, wherein the conduit is mounted on the outside of the bath.

16. Apparatus as claimed in claim 12, wherein the flow of nitrogen through the conduit is controlled by an electrically controlled valve.

17. Apparatus as claimed in claim 12, wherein the conduit extends though solder in the bath for at least part of its length.

18. Apparatus as claimed in claim 17, wherein the conduit has a first part having an open end positioned above the level of solder in the bath and a second part mounted on a bath cover, the second part mating with the first part when the cover is mounted on the bath.

19. A soldering apparatus as claimed in claim 2, wherein means is provided to move the solder bath in the horizontal plane.
